(19) United States
(12) Patent Application Publication
(10) Pub. No.: US 2011/0296616 A1
(43) Pub. Date: Dec. 8, 2011

(54) CUSHION WITH A STIFFENING INSERT

(76) Inventor: Conghua Li, Markham (CA)

(21) Appl. No.: 12/794,744

(22) Filed: Jun. 6, 2010

(51) Int. Cl. B68G 5/00; B68G 7/00

(52) U.S. Cl. 5/652; 29/91.1

(57) ABSTRACT

A flexible cushion has a shell and a stiffening insert inside the shell. The insert is partially immobilized relative to one or both surfaces of the shell to prevent bunching, or lumping of the insert. The partial immobilization is effected through the use of thin straps loosely intertwined with the insert and bonded to the edges of the shell, or through the use of a foil which holds the insert against one of the surfaces of the shell and is bonded to that surface through sufficiently large perforations in the insert to allow a degree of the insert in case of a deformation of the shell, for instance when the cushion is rolled up.

This application is a formal application claiming the priority of provisional U.S. patent application No. 61/151,251, filed Feb. 10, 2009, the specification of which is incorporated by reference herewith in its entirety.

### FIELD OF INVENTION

This invention relates to cushions or pillows used for the comfort of persons sitting, on chairs, benches, stools, sofas or the like or lying in beds or on the floors or the like.

### DISCUSSION OF PRIOR ART

There are many kinds of inserts used inside a shell such as pillows, mattresses, etc. Generally, the inserts have substantial thickness, and are attached to or compressed in substantial closeness to their enclosing shell. Mostly, they do not require a mechanism to hold them in place. Examples of such products are shown in the following U.S. patents:
U.S. Pat. No. 7,444,700, issued Nov. 4, 2008 to Koutsky et al.
U.S. Pat. No. 5,573,305, issued Nov. 12, 1996 to Storch,
U.S. Pat. No. 5,329,656, issued Jul. 19, 1994 to Leggett,
U.S. Pat. No. 5,176,860, issued Jan. 5, 1993 to Storch,
U.S. Pat. No. 5,117,517, issued Jun. 2, 1992 to Su,
RE 31,898, issued May 28, 1985 to Suter,
U.S. Pat. No. 4,039,363, issued Aug. 2, 1977 to Robertson,
U.S. Pat. No. 3,877,092, issued Apr. 15, 1975 to Gaiser,
U.S. Pat. No. 3,872,525, issued Mar. 25, 1975 to Lea et al.
U.S. Pat. No. 3,298,044, issued Jan. 17, 1967 to Saltness et al, and
U.S. Pat. No. 2,822,554, issued Feb. 11, 1958 to Wenzelburger.

A related US CIP patent application 2008/0256712 by this inventor describes a cushion device having a flexible, hollow shell and optionally a stiffening sheet-like insert disposed within the shell. The thin insert may be placed loosely inside the shell so as to offer, desirably, a minimum resistance in the case when the cushion is rolled up e.g. for storage or transportation. However, when the insert is loose, in certain situations it may “bunch up”, fold up or “lump” relative to the walls of the shell thus losing its co-planar relationship with the walls. This would cause an undesirable distortion of the intended flat shape of the cushion, similar to the “crinoline effect”, and would interfere with the functioning of the cushion.

Conversely, when the insert is fully integrated with the shell or fully welded thereto over the entire surface of the insert, the bunching up will be prevented, but the insert will provide a resistance when the cushion is rolled up.

### OBJECTS OF THE INVENTION

Accordingly, it is an object of the invention to prevent a sheet-like loose insert such as described in the above-referenced CIP application 2008/0256712, from bunching up relative to its associated shell, while retaining a degree of planar movement of the insert along the wall or walls of the cushion.

Further objects and advantages of the invention will become apparent from a consideration of the ensuing description and drawings.

### SUMMARY OF THE INVENTION

In accordance with one aspect of the invention, there is described a cushion comprising:

a flexible, hollow shell having two large opposed surfaces,

a sheet-like stiffening insert disposed within the shell, and

at least one thin, flexible flat strip associated with the insert and bonded to the shell such as to restrain lifting of the insert from one of the large surfaces while allowing a degree of movement of the insert substantially only along at least one of the large surfaces.

In an embodiment of the invention, the insert has at least one perforation.

In one embodiment, the strip is a narrow strap intertwined with the insert and bonded to the shell such as to allow a degree of movement of the insert along at least one of the large surfaces.

In another embodiment, the strip is a thin flexible sheet having at least one dimension larger than the corresponding dimension of the insert, the sheet and one of the large surfaces bonded together at the periphery of the shell and through the at least one perforation of the insert such as to envelop the insert and restrain its lifting from one of the large surfaces while allowing a degree of movement of the insert along at least one of the large surfaces.

In an embodiment of the invention, the at least one strip is fixedly secured to the insert.

In an embodiment of the invention, the material of the strip is compatible with the material of the shell.

According to another aspect of the invention, there is provided a method for manufacturing a cushion having two opposed large surfaces, the method comprising the steps of:

a) providing a perforated sheet-like insert,

b) providing at least one thin strip,

c) loosely engaging the at least one thin strip with the perforated insert,

d) bonding the strip to at least one of the large surfaces and

e) assembling the opposed large surfaces with the insert and the thin strip disposed therebetween so that the insert has a degree of movement along the large surfaces.

In an embodiment of the invention, the step c) comprises intertwining the strip with the insert through a perforation in the insert, and the step d) comprises bonding the strip to the large surface at the periphery thereof.

In another embodiment of the invention, the step c) comprises placing the insert between one of the large surfaces and a sheet of thin, flexible foil lying loosely against the insert, and the step d) comprises bonding the sheet of foil to the one of the large surfaces through the at least one perforation s o as to allow a degree of movement of the insert substantially only along the large surface.

### BRIEF DESCRIPTION OF THE DRAWINGS

Preferred embodiments of the invention will now be described with reference to the accompanying drawings, in which:

FIG. 1 is a perspective view of an embodiment of a cushion insert;

FIG. 2 is a perspective view of the insert of FIG. 1 with fastening straps;

FIG. 3 is a perspective view of another embodiment of the insert;

FIG. 4 is a perspective view of the insert of FIG. 3 with fastening straps;

FIG. 5 is an exploded perspective view of a cushion of the invention including the insert of FIG. 2;

FIG. 6 is an exploded perspective view of another embodiment of the cushion;

FIG. 7 is a top view of the assembled cushion of FIG. 6, and

FIG. 8 is a cross-sectional view along the lines A-A of FIG. 7.

FIG. 9 is a view of an embodiment of the cushion insert

### DETAILED DESCRIPTION

As illustrated in FIGS. 5a and 5b of the US patent application 2008/0256712, the cushion contains a stiffening insert 12 which is not fixed to the large surfaces 16, 18 of the shell. The cushion is intended to be quite thin, not exceeding 0.25 in. (6 mm) in thickness when open and flat. However, even at such a small thickness, when the shell is rolled up, the insert 12 will shift along the adjacent surfaces 16, 18 in accordance with the mathematical principles. Therefore, the dimensions of the insert should be somewhat lower than the dimensions of the encompassing shell surfaces 16, 18 to accommodate the shift.

When the above-described cushion is sufficiently deformed, in certain instances this loose insert/shell relationship may lead to a “bunching up” of the insert inside the shell leading to an undesirable appearance of the cushion and its somewhat less acceptable usage.

The term “bunching up” of the insert will be used throughout the specification as equivalent to pleating, lumping, folding or crinoline effect with respect to the insert's undesirable deformation within the cushion shell.

As stated hereinabove, it is desirable to prevent or reduce the possibility of the bunching up while allowing the insert to shift along the adjacent shell surfaces when the cushion is rolled up or otherwise deformed.

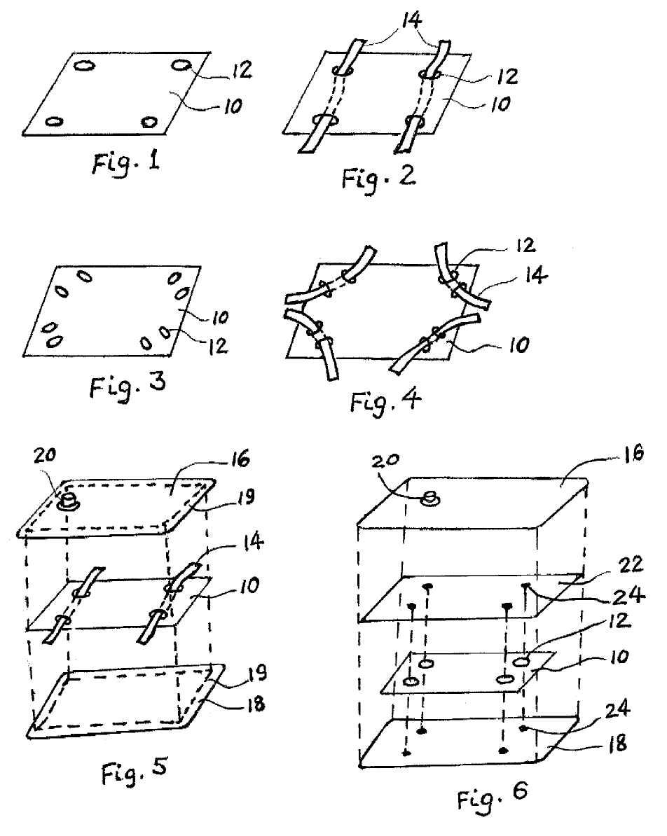

FIG. 1 illustrates an insert 10 made of a plastic material as described in the CIP 2008/0256712, the specification of which is incorporated by reference herewith. The insert has four apertures 12 sized to receive each a strap 14 shown in FIG. 2. The straps 14 are intertwined with the insert 10 and are loosely movable with respect thereto.

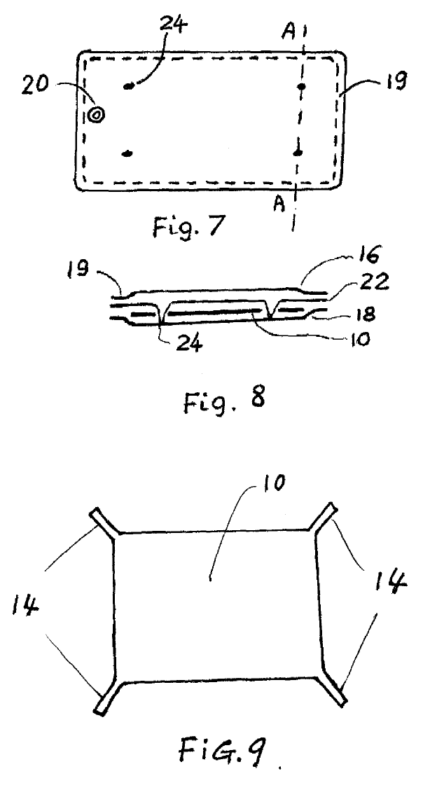

FIGS. 3 and 4 illustrate an analogous embodiment of the insert 10 with eight apertures and four straps loosely intertwined with the insert.

FIG. 5 illustrates an embodiment of the cushion utilizing the insert of FIGS. 1 and 2. It will be noted that, as illustrated by phantom lines 19 in FIG. 5, the dimensions of the insert 10 are smaller than those of the large surfaces 16, 18 forming the shell of the cushion, while the straps are long enough to match or extend the dimensions of the surfaces 16, 18. An inlet/outlet valve 20 is mounted in one of the large surfaces 16, to allow inflation of the cushion with a fluid and to hold the fluid inside the shell.

After the surfaces 16, 18 with the insert 10 therebetween are placed together, the surfaces 16 and 18, preferably made of a plastic material, are welded, sewn or otherwise fastened at their periphery, the ends of the straps being fastened to the edges of the shell 16, 18 as well. Due to its smaller dimensions, as explained above, and a loose association with the straps, the insert retains a predetermined mobility inside the shell along the surfaces 16, 18 but it is held against one or both of the surfaces 16, 18 by the provision of the straps 14 so that the possibility of bunching up is reduced or prevented.

The insert of FIG. 3 and FIG. 4 can be used as a replacement of that of FIGS. 1 and 2.

Another embodiment of the cushion is illustrated in FIG. 6. The cushion includes an upper surface 16 with the valve 20, a lower surface 18, the insert 10 with four apertures 12 and a retaining foil 22. During assembly, the foil 22 is first secured to the lower surface 18 so that the insert 10 is encompassed between the foil and the surface 18.

As shown in detail in FIG. 8, the attachment of the foil 22 to the surface 18 is effected at the peripheries of the surface 18 and the foil 22 as well as at a number of spots 24 which correspond to the placement of the apertures 12. The apertures are sized to allow a sufficiently strong attachment (e.g. welding) of the foil 22 to the surface 18, for instance a sufficiently large area of the spots 24, and also to allow for a movement of the insert along the surface 18 (which may not be planar due to a possibility of deformation of the cushion). The structure, as will be appreciated, should be effective in preventing or reducing the possibility of bunching up of the insert 10.

Alternatively, the foil 22 and the surface 18 may be bonded only through one or more of the apertures 12 without welding together (or joining in a different manner) at their peripheries 19.

In the next step of the assembly, the surface 16 is attached to the elements 22, 10, 18, for instance by welding of the materials of the surfaces 16 and 18 with the foil 22 if made of compatible materials. As indicated in the related above-reference CIP application, the cushion is made of plastic materials or impregnated fabrics, the insert 10 affording a degree of rigidity, firmness or stiffness to the cushion for easy handling and storage.

FIG. 9 shows an embodiment in which straps 14 are integrated with the insert 10, through such methods as, but not limited to, sewing, injection moulding or welding. The insert 10 can be injection moulded with strap portions 14 which are preferably thinner than the insert portion. The material of the insert 10 and of the straps can be selected, for example from known polymers, such that that the insert portion 10 will have a degree of firmness, rigidity or stiffness needed to afford the stiffness to the cushion as explained in the above referenced CIP application, while the strap portions 14 will have sufficient flexibility and/or elasticity to allow a degree of movement of the insert inside the shell when the straps 14 are secured to the periphery of one or both large surfaces (indicated as 16 with phantom lines in FIG. 9).

For the purposes of the specification, the term “strip” denotes either a strap 14 or a foil 22.

Although the description above contains many specifics, these should not be construed as limiting the scope of the invention but as merely providing illustrations of some of the presently preferred embodiments of this invention. For example, the insert, foil, straps, apertures and the large surfaces of the cushion can have many shapes and dimensions. While not illustrated, the foil 22 (FIGS. 6 and 8) may for example have only one dimension larger than the corresponding dimension (e.g. either width or length) of the insert, and is joined with one of the large surfaces at the edges of the larger dimension rather than at the entire periphery.

Thus the scope of the invention should be determined by the appended claims and their legal equivalents, rather than by the examples given.

1. A cushion comprising:
a flexible, hollow shell having two large opposed surfaces,
a sheet-like stiffening insert disposed within the shell, the insert having at least one perforation, and
at least one thin flexible flat strip associated with the insert and bonded to the shell such as to restrain lifting of the insert from one of the large surfaces while allowing a degree of movement of the insert substantially only along at least one of the two large surfaces.

2. The cushion according to claim 1 wherein the insert has at least one perforation.

3. The cushion according to claim 2 wherein the strip is a narrow strap loosely intertwined with the insert by way of said at least one perforation and bonded to the shell such as to allow a degree of movement of the insert along at least one of the two large surfaces.

4. The cushion according to claim 2 wherein the strip is a flexible sheet having at least one dimension larger than a corresponding dimension of the insert, the strip and one of the large surfaces bonded together through the at least one perforation of the insert such as to envelop the insert and restrain its lifting from one of the large surfaces while allowing a degree of movement of the insert along at least one of the large surfaces.

5. The cushion according to claim 4 wherein the strip and one of the large surfaces are bonded together at an area which is sufficiently smaller than the perforation to allow a degree of movement of the insert.

6. The cushion according to claim 1 wherein the strip and one of the large surfaces are bonded at the periphery of at least one of the large surfaces.

7. The cushion according to claim 1 wherein the strip and the shell are of compatible materials.

8. The cushion according to claim 1 wherein the at least one strip is integrated with the insert.

9. A method for manufacturing a cushion having two opposed large surfaces with an insert therebetween, the method comprising the steps of:
a) providing a sheet-like insert having at least one perforation,
b) providing at least one thin flexible strip,
c) loosely engaging the at least one thin strip with the insert,
d) bonding the strip to at least one of the large surfaces and
e) assembling the opposed large surfaces with the insert and the thin strip disposed therebetween so that the insert has a degree of movement along the large surfaces.

10. The method according to claim 9, wherein the step c) comprises intertwining loosely at least one thin, flexible strap with the insert through the at least one perforation of the insert, and the step d) comprises bonding the strap to the large surface or surfaces at the periphery thereof.

11. The method according to claim 9, wherein the step c) comprises intertwining at least two straps with the insert at two opposite edges of the insert.

12. The method according to claim 9 wherein the step c) comprises placing the insert between one of the large surfaces and a sheet of thin, flexible foil lying loosely against the insert, and the step d) comprises bonding the sheet of foil to the one of the large surfaces through the at least one perforation so as to allow a degree of movement of the insert substantially only along the large surface.

13. The method according to claim 12, wherein in the step d) the bonding through the perforation or perforations is effected at an area smaller than the perforation to allow a degree of movement of the insert relative to the area.

14. A method for manufacturing a cushion having two opposed large surfaces with an insert therebetween, the method comprising the steps of:
a) providing a sheet-like insert having at least two flexible straps,
b) bonding the straps to at least one of the large surfaces, and
c) assembling the large surfaces with the insert disposed therebetween so that the insert has a degree of movement along the large surfaces.
